(19) United States
(12) Patent Application Publication
(10) Pub. No.: US 2011/0033834 A1
(43) Pub. Date: Feb. 10, 2011

(54) ETEACHER - ELECTRONIC TEACHER FOR CONVEYING COMPLEX CONTENT FOR LEARNING

(76) Inventor: Peter Krumhauer, Berlin (DE)

Correspondence Address: BUCHANAN INGERSOLL & ROONEY PC, P.O. BOX 1404, ALEXANDRIA, VA, 22313-1404, US

(21) Appl. No.: 12/787,701

(22) Filed: May 26, 2010

Related U.S. Application Data
(63) Continuation-in-part of application No. PCT/DE2008/002158, filed on Dec. 23, 2008.

(30) Foreign Application Priority Data
Dec. 28, 2007 (DE) DE102007063345.0
Nov. 5, 2008 (DE) DE102008056014.6
Nov. 5, 2008 (DE) DE102008056015.4
Nov. 25, 2008 (DE) DE102008059172.6
May 28, 2009 (DE) DE102009023624.4

(51) Int. Cl. G09B 7/00

(52) U.S. Cl. 434/362

(57) ABSTRACT

Embodiments provide methods, devices, and programs that simulate a teacher who teaches a complex program system to a student in private lessons. Embodiments may further provide customized feedback and reinforcement to students. Teaching units and action trees for learning are also discussed.

The invention concerns a program system which simulates a teacher who teaches a complex program system to a student in private lessons. Areas of application are all educational areas, from the housewife who would like to learn Word up to the graduate engineer who would like to learn a new complex design program.

### STATE OF THE TECHNOLOGY

E-teaching belongs to the area of E-Learning. For this many different technologies which are used for didactically different representations are already known meanwhile. The most popular variations are web-based and computer-based training applications, author's systems, simulations, video conferences/Teleteaching, Learning (Content) management systems and digital learning games.

All these technologies serve, primarily to provide teaching material for the user in spatially and chronologically independent form.

Nevertheless, the disadvantages of the products available in the market are based above all in the fact that though the usual teaching programs are able to perform teaching material, mostly they act, nevertheless, on an artificial surface. They restrict furthermore the possibilities of the student strongly, while they mostly accept only one (before demonstrated) action at the repetition. They lack furthermore reactions to difficulties of the student—and hereby a very important component of a normal training: the feedback of the teacher to actions of the student!

From the document EP 0934581 B1, for example, a procedure is known for the automated training which generates student-profile data including knowledge gaps, and generates then an electronic student's workbook according to the student-profile data, and updates finally, in the feedback to the student-input data, the student-input data whereby according to EP 0934581 B1 a teacher- and a student-workstation are necessary.

Nevertheless, disadvantageous in the system according to EP 0934581 B1 it is that in particular a multitude of processors and workstations is necessary for the process.

### Objective of the New Procedure

Hence, objective of the present patent application is to develop a simplified program system which simulates a teacher as much as possible, is easy to be performed and to be generated and, moreover, is available to a wide user forum as a reasonable teaching aid. It should leave a lot freedom to the student at the repetition of the lesson and should give efficient help if the student gets into difficulties.

Hence, the project is called—parallel to ‘Elearning’, ‘Eteacher’—electronic teacher. This objective is solved according to the claims. Herefore, the invention concerns a device/a system according to claim 1, a procedure according to claim 66, a computer program product according to claim 82 as well as a computer according to claim 83. The other claims concern preferential implementation forms of the invention. The examples used here are shown partly in English language.

### General Process of the Teaching by the Eteacher

A teaching unit consists generally of 2 parts:
1. In the first part a lesson is demonstrated to the student by the teacher.
2. In the second part the student can repeat the lesson. The correctness of his actions is checked, if they do not serve to solve the tasks of the lesson, the student gets a hint to correct his fault.

### Process of the Analysis of the Actions of the Student in Comparison to the Demonstrated Lesson

Here are three basic analysis methods which can be mixed too:
1. The examination of the single actions by comparison with the action tree of the lesson
2. The examination of parameters of the tables which are input by the actions.
3. The examination of the results of the actions of the student

These analysis methods should be explained here basically:

### Analysis of the Actions of the Student by Examination of the Consistence to the Action Tree of the Teaching Unit

### Representation of the Actions of a Unit in the Unit Graph

The actions of the teacher and the student are shown here in a spreadsheet—they consist basically of 2 elements:
the object which is activated by the action (an object is every entity of a program application—e.g., a menu function or a part of a structure—which can be activated by clicking)
of the action which indicates what should happen with this object:

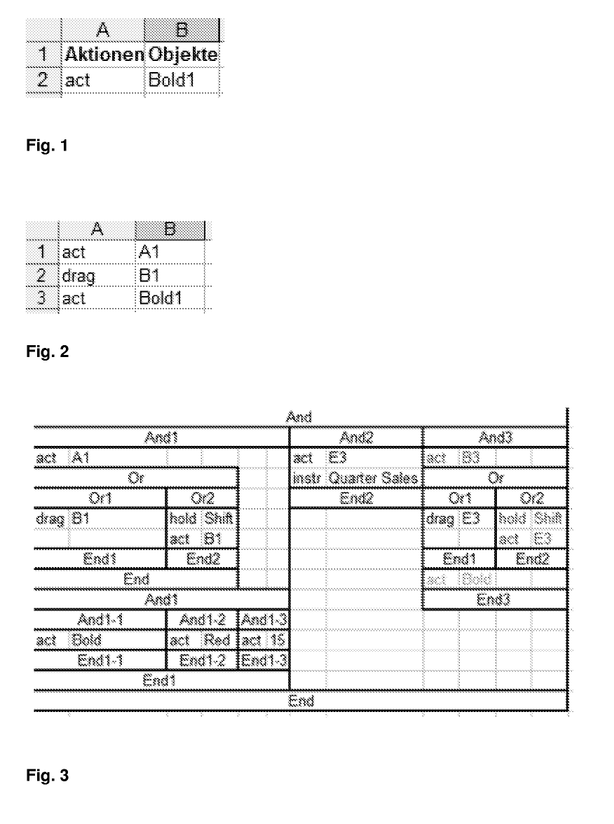

In FIG. 1 (representation of an action in the unit graph) Bold1 is the object (the button Bold in Excel) that is activated by clicking (act=activate).

### Generation of Action Paths in the Unit Graph

Actions which are executed successively are shown in an action path—e.g.: FIG. 2 (representation of an action path in the unit graph)

Here in the program application Excel
the cell A1 is activated and thus marked, then
from here with pressed left mouse key the cursor is dragged to the cell B1—then
the object Bold1 (the button Bold1) is activated and the contents of the cell compound A1:B1 is formatted to bold.

### Enlargement of the Action Paths to Action Trees by Insertion of Branching

FIG. 3 shows as an example an action tree with And Or branchings. All And branchings must be passed in parallel to the other And branchings—while from the Or branchings only one of the branches of the action tree must be passed.

The action tree shows the following task as whole:

The 3 And branches show respectively a cell compound with its setting of tasks:
And1: The cell compound A1:B1 must be first marked (2 alternative possibilities in Ort and Or2) and then formatted to bold (And1-1), red (And1-2) and 15p (And1-3)
And2: E3 (a single cell) must get the string ‘Quarter Sales’.
And3: B3:E3 must first be marked (Or1 and Or2) and then formatted to bold

### Internal Representation of the Action Trees in Tabular Form

The representation as action tree is used for the graphical representation because it mirrors well the dependencies—for the internal program-technical representation the tabular form is chosen, because it is easier to be programmed. The branch And3 would look, e.g., in this form as follows:

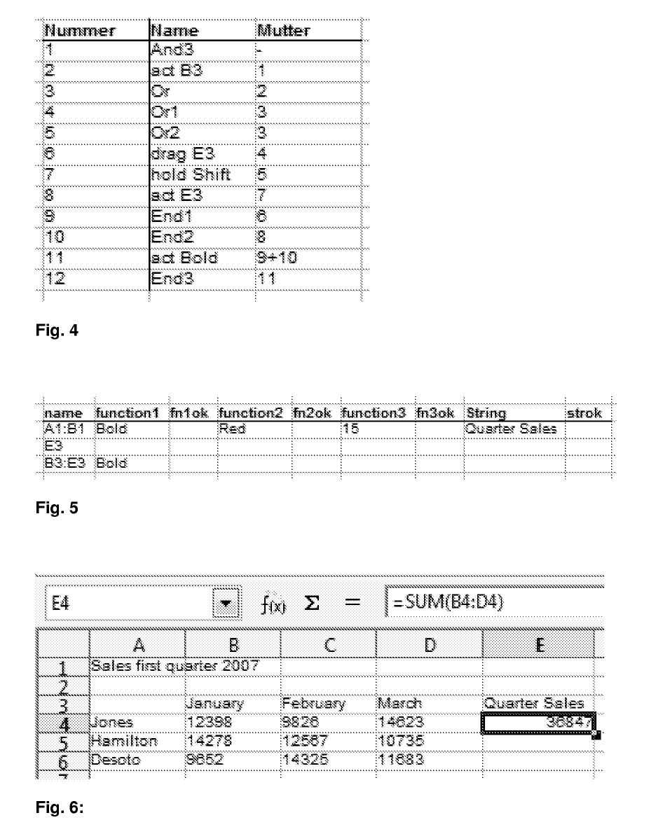

FIG. 4 shows the branch And3 of the action tree in FIG. 3 in tabular form—whereby the branchings are represented by the indication of the mother's cell. Action paths arise hereby by tracking the mothers—the left branch of And3 yields (here from below to upwards), e.g. from

| Name | Mother's No. | Name of the mother |
|---|---|---|
| End3 | 11 | act Bold |
| act Bold | 9 (+10) | End1 |
| End1 | 6 | drag to E3 |
| drag E3 | 4 | Or1 . . . |

to End3/act Bold/End1/drag E3/. . .

Tree representation and table representation can be transferred without loss into each other.

### Examination of the Observance of the Action Tree

The supervision of the observance of the action tree by the actions of the student shall be demonstrated by the example of the tree in FIG. 3:
act B3—he activates the cell B3—this action is shown in the branch And3: OK!—the next possible action would be either to (drag E3) or to hold the Shift key (hold Shift).
hold Shift—this action is permitted too, because it is contained in the sub-branch Or2 of the Or branching in the tree. The next possible action is ‘act E3’—he would have marked hereby the cell compound B3:E3
act E3—OK!—his next possible action is ‘act Bold’—he would format hereby the contents of the cell compound B3:E3 to bold
act Italic—wrong: The student leaves the tree and triggers hereby an error message—e.g., ‘Attention, this is not the right font style! . . . ’
   Analysis of the Actions of the Student by Examination of the Table Parameters that where Generated by him

Another kind of representation of the demonstration of the solution paths of the teacher is the tabular form:

FIG. 5 shows the overall task of the action tree in FIG. 3 in tabular form: The 3 rows of the table show the partial tasks:
A1:B1 must be formatted to bold (function1), red (function2) and 15p (function3)
E3 (a solitary cell) should get the string ‘Quarter Sales’ (string).
B3:E3 must be formatted to bold (function1)

The action path of the student shown in FIG. 3 (with improvement of his fault) would cause the following
act B3 is the start cell of the cell compound B3:E3: OK!
hold Shift preparation for marking of the compound: OK!
act E3 the end cell E3 extends the compound to B3:E3—now this cell compound is active in the table: OK!
act Bold the function Bold has been activated by the student—hence, fn1ok is set to =1: OK!—for the entire solution of all tasks of the table the other fnok and the strok would have been to be set to 1!

Another sample of the possibilities of the table analysis can be shown with the menu function ‘rectangle’ in Solidly Edge:

If this function is called, a new rectangle object is called by the program as table with the following parameters and sub-parameters:
Name
Start point/position (in Solidly Edge the rectangle is defined by declaration of both diagonal corner points)
End point/position
Upper line/start point/position+end point/position/measure
Lower line/start point/position+end point/position/measure
. . . .

If now menu functions are called which yield informations for these parameters—e.g., the function Measuring—their data are stored to the respective parameters.

It can be shown that the table representation in comparison to the action tree representation is easier—it assumes however that the given task can be represented in tabular form.

### Analysis of the Actions of the Student by Examination of his Results

The registration of the actions of the student as parameters of a table is in effect the representation of a result of an action in contrast to the first analysis method in the real sense where the action itself was analysed—the second method of the registration of table parameters can be seen as sub form of the result analysis.

Here a further sample should be demonstrated:

In FIG. 6 the generation of a formula is shown. For the generation of this formula here are many possibilities—e.g., by marking of the formula cell E4 and then
the activation of the sum symbol
the input of the formula using the keyboard
the activation of the equality symbol and then by input of the rest of the formula . . . .

The representation of all possibilities by an action tree would require a very big tree—for a parameter representation in a table analysis the string must be known at the beginning—if the cells or functions are only activated and no string is written the string cannot be input as parameter into a table. Here the content of the input line is used as a result of the formula representation of the student: the formula in the line is detected with the help of OCR (optical character recognition) and is compared in the analysis with that of the teacher.

### Standardization of the Formula Shown in the Command Line

The right formula for the above example is (see FIG. 6) ‘=SUM(B4:D4)’.

### Accepted by Excel is

‘=Sum (d4:b4)’ with additional blanks and exchange of the cells.
Not accepted is however
‘=SUM (B4: D4)’ with a blank between the cells!

This ambiguity is overcome for an unequivocal control by the fact that before the check an automatic standardization of the formula occurs which turns e.g. ‘=sum (d4:B4)’ into the standardised form ‘=SUM (B4:D4)’.

If faults are recognised within this standardization—e.g. a blank between the cells—a specific error message is given—e.g. ‘Here should be no blank between colon and cell!’

### Other Forms of the Analysis of Results

Other possibilities of the analysis of results arise, e.g., with design programs by the graphic evaluation of drawings where the results of teacher and student, e.g. are compared by bitmap comparison.

### Choice of the Analysis Form for a Lesson Respectively for a Part of a Lesson

The optimum analysis form is given to a great extent dependent on the kind of the objects:

### Table Analysis

Always then when the object admits a firm number of operations, these can be stored as a parameter to the object. Examples for this are:
Cells of spreadsheet programs (like Excel) with their restricted kind of procedures
Structures as rectangle, circle etc.—here exist generally a restricted number of operations and parameters—for the rectangle, e.g., the parameters Measure or Symmetry to the zero point or the operation ‘rounding of corners’

### Results Analysis

Always then when the realisation of a result is substantially more difficult than the result itself and if the result can be easily analysed, this analysis form is suitable—an example is (like shown above) the input of a formula in Excel.

### Action Tree Analysis

This analysis form is always possible. Moreover, this form has the advantage that faults of the student can be detected early and very specific fault comments can be given. As cited already above, these analysis forms can be mixed in a lesson.

### Process of the Generation of Teaching Programs

### The Program Development Core for all Program Systems

Here is a common developing core for the development of the teaching programs for different program systems. This core contains all program tools which generally are necessary—regardless of the teaching program system—for the development of the teaching programs—e.g. tools for the recognition of the activated objects (an object is every entity in the program system that can be activated by clicking).

### The Development of Single Program Systems

### Development of the Program Specific Tools for Different Teaching Units

While the tools that are needed for several program systems are included in the developing core, the program specific tools that are needed for different teaching units are generated in the next step of the development. A sample for this kind is the tool position-to-cell for the program application Excel that converts a cursor position into the adequate cell.

### Determination of Program Specific Objects for Different Teaching Units

The objects which should be used for several teaching units are determined in this step. These are for example the menu functions which might be activated and whose activation is detected by the analyser program using stored parameters of them—in Excel for example the menu function Bold which formats the content of the marked cell to bold.

The determination of these objects and the generation of their analysis parameters should be explained here for specific samples:

### Registration of the Object in the Object Table of the Program System

All relevant parameters of the object are stored in a table, these can be, e.g.:

### Name of the Object

The object is called by its name.

### Object Type

The object type determines how it is detected which object was activated.

For different program systems here are different object types (with partly specific parameters), e.g.
Pixel Object—its activation is recognised by its verification pixels—see below
Position Object—it is detected by the fact that the cursor at activation is in an activation field whose corner points are stored
Text Object—it is recognised by the fact that a string is input into a given activation window that is detected via OCR (optical character recognition).
Cursor marker Object—these objects generate if they are activated by the cursor a specific marker whose position moves relative to the cursor—e.g., a marker which indicates the center of a line. To detect if this object was activated it is examined if the bitmap of this marker is found in a specific position relative to the cursor.
Fix marker objects—here a marker is shown too—but in this case the marker is in a fixed position

### Activation

This parameter shows whether the object is activated or not

### Verification of Pixel of Objects

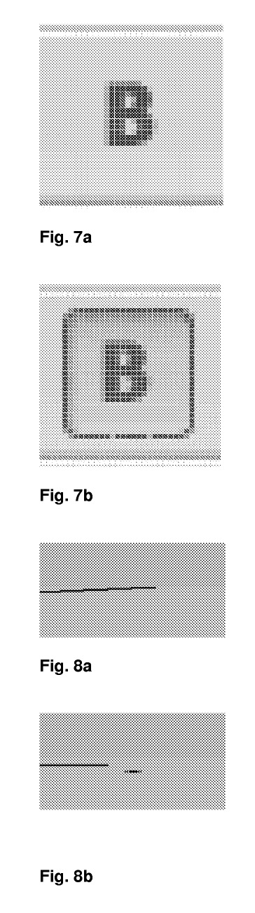

The verification of pixel objects should be demonstrated at the example of the object Bold. For ‘Pixel objects’ the fact is used that in most programs the objects change their color if they are activated—FIG. 7a shows the object ‘Bold’ in the non-active state before the cursor steps into the activation area and FIG. 7b the same object in the active state subsequent to the cursor has moved into the activation area. It can be recognised that single pixels of the object change their color in the active state. This color change can be used to check whether the student has activated this object: 2 pixels of the object with changed color are stored (partly automatically)—the ‘verification pixels’ (see in FIG. 2b the two pixels in the lower frame). The color of these pixels on the screen are compared with the stored colors—if they are identical, the student has activated the object.

### Automatic Regulation and Storage of Marker to Objects

In some programs certain properties of objects are displayed graphically. In an example FIG. 8a shows the generation of a line (in the program application Solid Edge) which is not exactly horizontally.

FIG. 8b shows how the marker ‘Horizontal/Vertical’ (the symbol beside the line) is added automatically by the program if the end point of the line is positioned exactly on the same y or x as the start point—if, hence, is exactly horizontal or vertical.

In this case the marker is positioned always in the same relative position to the cursor—in other cases it is positioned in a fixed position to the object.

With activation the marker is detected and the parameter Horizontal-Vertical of the line is set to 1.

### Compression of Parts of an Action Trees to a Super Object

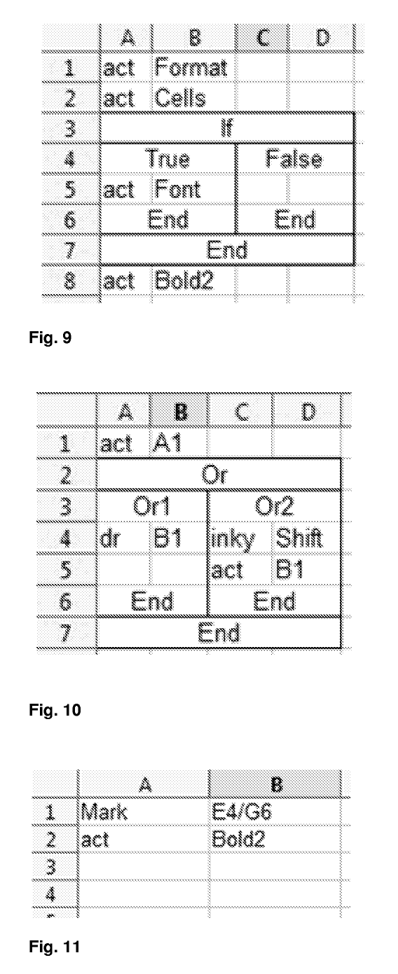

FIG. 9 shows a cut out from an action tree which describes a proceeding—the formatting of a marked cell or a cell compound—which will occur in several lessons for the program system Excel.

Such combinations of actions can be summarised to a super object:

### act Bold2,

where Bold2 is a super object with the parameter ‘condition’ (here: If Font is not active yet) and is stored in cell A3. To the super object the tree, the name of the super object, the parameters and their relation to the tree is stored to the tree.

### Generation of a Super Action

FIG. 10 shows a cut out from an action tree which describes a frequent action: two possibilities to mark a cell compound.

Here the tree is combined to a super action:

Mark A1/B1 where A1 is stored as start cell in B1 and B1 as a end cell in D5 and Mark as name of the super action.
The parameters can be exchanged: The expression
Mark D5/E6 would mark accordingly a cell compound D5:E6.

### Combination of Super Objects and Super Actions to Further Super Unities

FIG. 11 shows a sample of an action path with super entities that are already combined. This is a frequent used proceeding too: the formatting of a cell compound. This combination of actions result is combined again to a new super action:

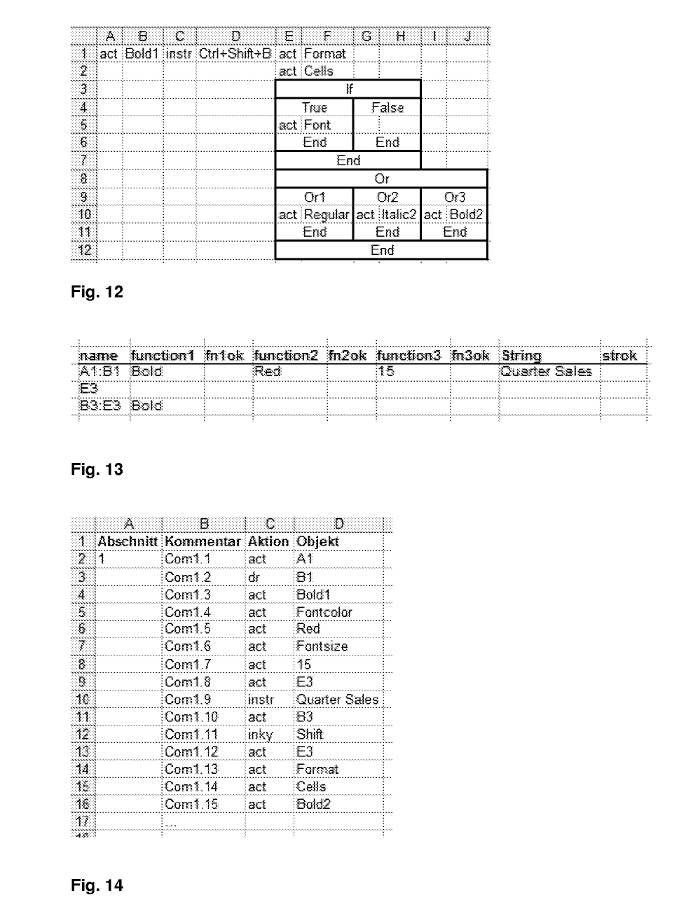

Format E4/G6/Bold2 where Format is the name of the super action and E4 to Bold2 show his parameters. The parameters are replaceable again—format D5/F7/Italic2 would format accordingly the cell compound E4:G6 to italic.
Generation of the Menu Tree of the Program System Other super actions and super objects can be automatically generated with the help of the menu tree. The menu tree contains all menu objects of a program system (in FIG. 12 is shown a cut out from the menu tree of Excel). Additionally the menu tree contains all actions which do not use objects: Fore example: the action ‘Instr Ctrl+Shift+B’ generates e.g., by key input the string Ctrl+Shift+B and thus formats the marked cell compound to bold. Other possibilities of the same function: act Bold1 (Bold1: the button Bold) or Bold2 (subsequent to activation of the object Format and then Cells and—if not yet active—Font and then Bold2).

All menu objects of the menu tree automatically generate super actions: act Regular would be such a super action—it substitutes the path:
act Format
act Cells
act Font (if not already active)
act Regular

### Definition of Function Objects

Function objects are a special form of menu objects: they represent different objects with the same task—in FIG. 12 e.g., the menu objects Bold1 and Bold2 and the string Ctrl+Shift+B would perform the same task (to format to bold). They represent the common function object Bold.

act Bold would be thus the instruction to perform one of three possibilities to format a marked cell to bold.

The menu tree is stored only for the optical representation in the form shown above—internally it is stored in tabular form with naming of the respective mother (see above).

### Examination of the Correctness of Actions of the Student Using the Table Analysis and the Menu Tree

FIG. 13 shows (as did already FIG. 5) an easy example of a table representation of the tasks. If e.g., the student has marked the cell compound B3:E3, then he must format this according to the table to bold (Bold). According to the menu tree (FIG. 12) he has here 3 solution ways through the menu tree. His actions are checked now whether he follows one of these solution ways:

act Format would be to a right action for this task as it can lead to one of the 3 solutions
act Tools would be a wrong action—it does not lead to one of three solution ways of the menu tree. This action would be quit with the fault comment ‘This cannot lead to a solution of the started task!’

In the next step would e.g.

act Cells be a right action—the analysis program knows the instantaneous position in the menu tree (Format) and recognises that via Cells the task (formatting the cell compound to bold) can be reached.

This analysis can be used for every function of the menu tree.

Generation of the Lesson by the Teacher with the Help of the Recorder

Until now all explanations dealt with general problems not with specific tasks for a given lesson. Now in the next step the lesson is generated which is performed to the student at the beginning of the teaching unit. This contents
all actions of the teacher (as for example mouse actions or key actions) and
in parallel all spoken comments of the teacher.

These are recorded by the program ‘Recorder’ and can be replayed again later. The graphic representation of the lesson is the lesson graph which is—as the unit graph—a spreadsheet representation of the actions and the comments.

The cut out (FIG. 14 lesson graph) shows an exemplary representation of this lesson graph. In addition to the actions and objects the lesson graph contains segments and comments.

Segments are autonomous parts of a lesson which can run independently. Hence, they contain an own start screen and all tables which are needed for their demonstration. Lesson comments are assigned to the segments.

### Reset of the Screen

The control of the actions of the student is based on the fact that the objects of his actions are recognised by the program Analyser. This is no problem as long as these are menu objects with known position on the screen.

Nevertheless, it can become a problem if these are objects which are generated by the student—e.g., a design drawing. Should e.g., lines get measured, they must be activated before. To check whether the student has activated the right object, its parameters must be stored. If the teacher activates this object its verification pixels can be assigned to the object and can be stored. However this might not be possible for the objects that are generated by the student.

Here the reset of the screen takes effect: If the student has generated the drawing and wants now to measure the design the teacher intervenes:
he gives the comment ‘Let me reset your drawing by mine!’
now the screen with the drawing of the teacher is shown—with the known and stored verification pixels.

If the student wants now to activate lines for the measuring, the analyser can check these. It is important that the reset is not done before the previous actions of the student
here the drawing of the rectangle—have been checked!

### Add Ons for Slower and Cancelations for Quicker Learning

Every teaching unit is offered with different teaching speeds for students with different learning speeds. These different teaching speeds can be generated e.g. by the fact that additional explanations are inserted or cancelled in the editing process. Otherwise lessons at different teaching speed can be generated from the beginning.

### Adaptation of the Lesson to the Learning Speed of the Student

At the first start of a lesson in the program system the learning speed to be expected of the student is determined by a number of questions and is assigned to the student's profile. If the student does too much faults or if he is able to perform the lesson without errors the learning speed is lowered or raised in his profile and the next lessons are offered to him with this learning speed.

### Learning Speed-, Aim- and Knowledge Profiles

Basis of the teaching are the following profiles:
The learning speed profile of the student (see above).
the aim profile of the student is given by his learning objective of the student which is defined at the beginning of the teaching using a special program
the knowledge profile of the student defines which of the teaching contents of the learning objective is already known by him. This is determined by a test at the beginning of the teaching
the gap profile arises from both together: all teaching contents which the student still lacks for the reaching of the learning objective
every teaching unit has its own teaching profile: The sum of the teaching contents which it provides.

### Adaptation of the Knowledge Profile of the Student and Choice of the Next Teaching Unit

Subsequent to the end of every teaching unit the knowledge profile is adapted by the protocol of the unit—all teaching contents are stored together with the rating how well they are mastered (how many faults where made, if a intensification was requested . . . ). This yields now again the actual gap- and learning speed profile.

From these the optimal next teaching unit is determined as that whose gap profile covers in the best manner the gaps for the achievement of the learning objective.

### Generation of the Teaching Unit

### Generation of the Lesson Graph

Manifestation of the teaching unit is the lesson graph which contains all information which is needed by the analysis program for the examination of the actions of the student.

According to analysis form this information looks different:
For the table analysis and for the result analysis it is a set of tables
For the action tree analysis it is the entire action tree.

### For the Tables and the Result Analysis:

Automatic Generation of the Tables from the Action Path of the Lesson

FIG. 15 shows once again (how already FIG. 14) the action path of the teacher. It can easily be seen that the informations about action 2 to 8 can be inserted relatively easily in a cell compound table with the following parameters:

| | |
|---|---|
| Name: | A1:B1 |
| Start cell: | A1 |
| End cell: | B1 |
| Function1: | Font style Bold |
| Function2: | Font color Red |
| Function3: | Font size15p |

The later actions can be easily converted into parameters too.

In the same way the formula can be interpreted, e.g., as parameter ‘string of a cell’ (see FIG. 5)

Thus other table parameters can be taken from the lesson path:

If e.g., the object ‘Rectangle’ has been generated in a design program in the editing phase as a table object with its parameters and is called now in the action path it is installed as new table object and the following actions—e.g. Measuring—generate the respective table parameters.

### For the Action Tree Analysis:

### Automatic Extension of the Action Path of the Lesson to the Action Tree

The lesson graph shows the action path of the teacher with the actions selected by him for the solution of the tasks of the teaching unit. Nevertheless, the student can choose other solutions—hence, for the analysis of his actions the action tree must be given with all possible solutions. This enlargement can be generated partly automatically in the following steps:

The action path of the lesson graph (FIGS. 14 and 15) is examined action for action whether fragments of the path are entire branches of stored super actions, super objects or from menu branches of the menu tree:

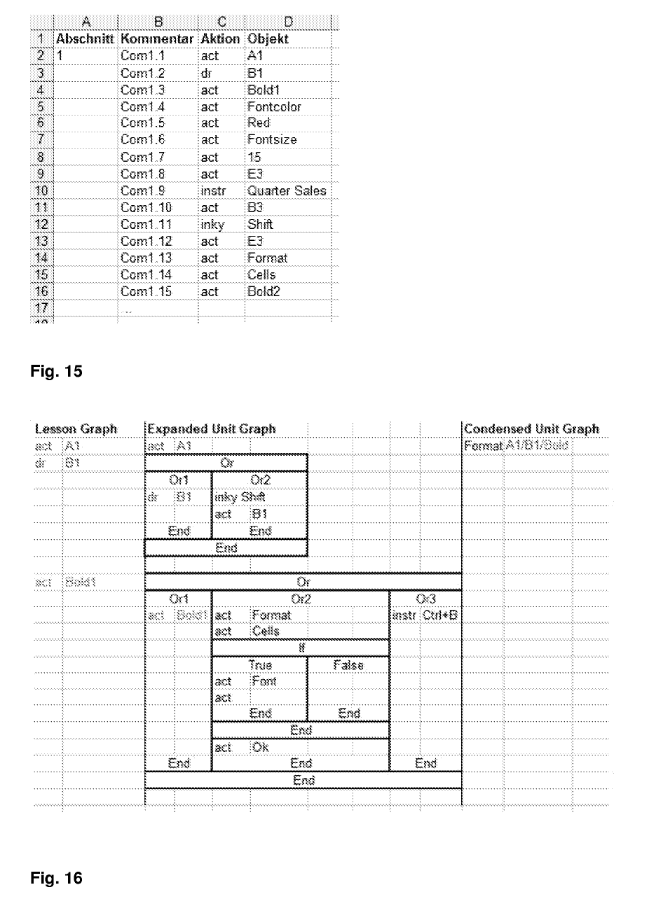

FIG. 16 shows the automatic enlargement of the action path of the lesson graph into the compressed representation of the action tree of the unit graph in 3 steps:

Here the 1st and 2nd step—on the left the action path of the lesson graph is shown—the path fragments which exist as entire branches of super unities (super actions, super objects or functions) are framed:
act A1+drag B1 is an entire branch of the super action Mark/A1/B1 (FIG. 10)
act Bold1 is an entire branch of the menu tree (FIG. 12) and is linked by the function table with the function Bold and can thus be substituted by act Bold
   Both substitute the initial actions in the enlarged representation.

In another enlargement both form again the entire branch of the super action Format/A1/B1/Bold (FIG. 11)—this represents now the compressed representation on the right side. The expanded and the compressed representations illustrate the same tree—one is used for the analysis, the second for an easy editing of the action tree.

### Enlargement of the Action Tree by and Branchings

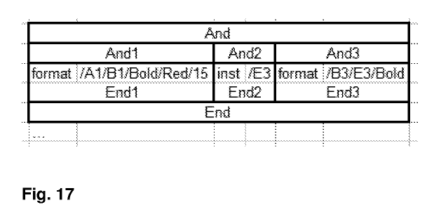

In a further step the structuring of the teaching contents is done: Parts whose sequence is not given can be arranged parallel by And branchings—FIG. 17 shows a sample—other parts which represent alternative solutions can be arranged as Or-branchings.

### Analysis of the Repetition of the Lesson by the Student

This step is already described by the presentation of the different methods of analysis
the table analysis
the result analysis and
the action tree analysis

### Fault Comments

### Generation Fault Comments

If an action of the student turns out to be wrong a fault comment is given.

This fault comment is stored in general to the action in the action tree (in the case of action tree analysis) or to a parameter in the set of tables (in the case of table analysis) which is injured by the action of the student.

If the student activates e.g. Italic instead of—as told by the table or by the action tree—Bold, he gets e.g. a general fault comment: ‘This is not right!’

| | |
|---|---|
| , Would you like to try once again | F1′ |
| , Would you like me to explain the fault? | F2′ |
| , Would you like me to show you the right action again? | F3′ |

If the student chooses, e.g., F3 the segment with the right action is shown again.

### Concatenated Comments

For a specific characterization of a fault concatenated comments with generic and specific comment parts can be used—e.g., with the generic components ‘Attention:’ and ‘is already active!’ which is given always when the parameter act ( ) is injured and the specific part ‘Font’ of the object which is linked to the injured object.

Concatenated the comment is: ‘Attention:+Font+is already active!’
Concatenated parts simplify the fault comments considerably.

### Intensification

Here are cases in which students react differently—even those who where classified with the same learning qualification and hence get the same teaching units with the same teaching speed. An example is the formula for the determination of the bonus (see above in FIG. 1): For some students this formula may be clear at first sight, for others it is difficult to understand!

For these students an intensification is offered in which the basis of the use of formulas is explained at easy examples.

### The Help Button—and the Help Key

Adjacent to the communication shown on top between student and teacher—steered by the analysis program—the student can activate at any time the help button or the help key (question mark) if he didn't understand something.

In this case the Analyser offers him the following assistances:

If the problem appears in the presentation phase:

| | | |
|---|---|---|
| , Would you like you to see the | F1′ | |
| last action once again? | | |
| , Should I repeat the last | F2′ | |
| segment once more? | | |
| , Would you want an intensification | F3′ | (This only if an |
| to the last segment? | | intensification is stored |
| | | to the segment) |
| , Is my presentation too fast? | F4′ | (The last |
| | | segment is shown now at a |
| | | slower teaching speed - this |
| | | only if not already the |
| | | slowest teaching speed is |
| | | given. |

If the problem appears in the repetition phase:

| | |
|---|---|
| , Would you like to see which action(s) you could do now? | F1′ |
| , Should I repeat the segment once again? | F2′ |

Premature Repetition and Single Step Repetition with ‘Split of Screen’

The student doesn't have to wait to the end of the presentation of the teacher—he can tell at any former time that he wants to repeat the contents that where presented—in the extreme case he can ask for a single repetition using a ‘split of screen’: Here teacher and student each have an own screen—each action of the teacher is repeated by the student. These screens can be arranged side by side or can overlap partially where always one of both is in the foreground.

Offer for a Further Training with the Same Teaching Contents but without Previous Presentation

Subsequent to the repetition of the teaching unit the student gets the offer to perform a similar unit with the same teaching contents which however is not taught before by the teacher.

### Feed Back of the Faults of the Student Via Internet

The student can choose at the start of the programs a setting which stores the protocol of his teaching unit (his action paths, his faults and the communication with the Analyser) and automatically sends this protocol from time to time via Internet to the developers of the teaching unit. Here they are evaluated automatically and serve for the improvement of the teaching units.

As incentive he can get bonus points for every protocol which lead to a price reduction for the next update of the program.

### Inquiry of Program Errors by Independent Testers

A frequent source of error of program systems derives from the fact that the test of the developed program is done by the same developers or by persons from the same company who dispose of a similar state of knowledge to that of the developer. This leads often to the problem that the testers do not recognise possible difficulties of the user. For the Eteacher another test procedure is suggested:

The single teaching units are supplied to several persons who have the same knowledge and a similar learning speed like the user to be expected. It is important that these testers have as little knowledge of the program as the expected user will have. If now one of these testers tests the program, all of his actions are recorded in a test protocol—as soon as he comes into difficulties, he can input them into a window. Then this test protocol is forwarded to the developer and the new improved program again to an other tester.

### Particularly Preferential Embodiments of the Invention

The invention is based among other things on the statement that a system, providing a (a) demonstration phase in which teaching material is shown to a student is performed and (b) a repetition phase in which the teaching material is repeated by the student is particularly suited for the generating of didactic programs which are composed of several single teaching units and which are performed individually by a student if every action of the student is controlled during the repetition by an analysis program.

Hence, the invention concerns in particular a device or a system as well as a procedure for generating didactic programs where the didactic programs are composed of several single teaching units which are performed individually by the student where and the basic construction of a teaching unit consists in the fact that first in a presentation phase teaching material is performed and can be repeated then in a repetition phase of the student, where every action of the student is controlled by an analysis program.

By device or system according to the invention is understood in particular every device or arrangement on which the following features, in particular procedure steps, according to the invention can be proceeded (e.g., a data processor, in particular computer, with a connected display and input unit). Accordingly the device or the system according to the invention consists of an analysis program respectively an analysis program is performed on the device respectively the system.

According to the invention the analysis program analyses every single action of the student according to the following pattern:

does it correspond to the action of the teacher for the solution of a task of the lesson?

is it helpful for the solution of a task of the lesson that is not solved yet? has the student solved all tasks?

If the student does a fault (e.g., if the student has solved not all tasks according to the actions of the teacher) the analysis program gives suitable comments.

In a particularly preferential implementation form of the invention a compressed lesson table is used in this analysis (in particular according to table A) with actions or super actions and their specific parameters that shall be used for the lesson.

The compressed lesson table is a listing of super actions or actions and their parameters of a lesson. The super actions are split again in the action table in their single actions.

E.g., the super action Frmt with its specific parameters A1, B1, Bold, 14 and Red has the task to format the contents of the cell compound A1:B1 to bold, 14p font-size and red. This super action is composed again of the new super action Mark CISt (start cell), CIEn (end cell) (with the task: Mark the cell compound from the start cell to the end cell) and the single actions act StI1—activate the button of style1=Bold, act StI2—activate the button of StI2=14p . . . .

The new super action Mark CISt, CIEn is composed again (see below) of single activites act Clst . . . act CIEn.

The super actions—e.g., Mark CISt, CIEn—are generally applicable, hence, they contain no specific but generic parameters—e.g., the super action Frmt in the super action table (see below) has instead of the specific parameter Bold the generic parameter StI1.

### Control of the Actions of the Student by a Compressed Lesson Table and a Super Action Table

The application of the tables should be explained with the help of the tables A and B in which the beginning of a teaching unit is shown:

TABLE A
Compressed lesson table (cut out)

| rw | step | stat | ifdn | logop | s- act | par1 | par2 | par3 | par4 | par5 |
|---|---|---|---|---|---|---|---|---|---|---|
| 1 | 1 | 1 | 0 | | Frmt | A1 | B1 | Bold | ! 14 | Red |
| 2 | | 1 | 0 | | Instr | E3 | St1 | | | |
| 3 | | 1 | 0 | | Instr | E4 | ! st2 | | | |
| . . . | | | | | | | | | | |

un = unit

TABLE B
Super action table (cut out)

| Sact | rw | par1 | par2 | par3 | par4 | par5 | stat | ifdn | logop | s- act | par1 | par2 |
|---|---|---|---|---|---|---|---|---|---|---|---|---|
| Frmt | 1 | ClSt | ClEn | Stl1 | Stl2 | Stl3 | 1 | 0 | | Mark | ClSt | ClEn |
| | 2 | | | | | | 0 | 1 | | act | Stl1 | |
| | 3 | | | | | | 0 | 1 | | act | Stl2 | |
| | 4 | | | | | | 0 | 1 | | act | Stl3 | |
| Mark | 1 | ClSt | ClEn | | | | 1 | 0 | | act | ! ClSt | |
| | 2 | | | | | | | 1 | Or1 | dr | ! ClEn | |
| | 3 | | | | | | | 1 | Or1 | inky | Shift | |
| | 4 | | | | | | | 1.3 | | act | ClEn | |
| . . . | | | | | | | | | | | | |

sa = super actions

At the beginning of the compressed lesson table is the super action Format with the short form Frmt which tells that the cell compound with the start cell A1 (par1) and the end cell B1 (par2) has to be formatted to bold (par3), to the font size 14p (par4) and red (par5)—the exclamation marks are explained later.

We find this super action again in the super action table—here with its generic parameters par1 . . . par5 on the left side and its single actions or super actions with their generic parameters par1 . . . par2 on the right side.

The specific parameter A1 (par1 from the lesson table) is shown here as generic parameter CISt (CellStart=start cell) and the specific parameter Bold (par3) as generic parameter StI1 (Style1).

The first action—here super action—the super action Frmt is Mark: first the cell compound must be marked: this refers to the super action Mark in the super action table this again refers to its single actions: first the start cell A1 must be marked and then (in row rw2) either the cursor must be dragged with shifted mouse button to the end cell B1 (dr CIEn) or the Shift key must be pressed (inky Shift) subsequent to which action in each case the end cell B1 must be activated (act CIEn).

The Or-form of both possibilities is represented by the entry Or1 in the column logop (logical operation).

In the column ifdn (if done) is shown which action must be performed previous to the action, e.g., for the last action act CISt in rw=4 the action act CISt in rw1 as well as the action inky Shift in rw3 must be performed.

Subsequent to the performance of the super action Mark CISt, CIEn (rw1 in the super action Frmt CISt, CIEn, StI1, StI2, StI3) either the function StI1=Bold or the function StI2=14 or the function StI3=Red must be performed.

In the column stat (status) it is indicated which of the actions (or super actions) can be performed (stat=1). This is always the case when the ifdn-column of the same row indicates an action which is already performed—in the lesson table (table A) the ifdn column=0 registers for the first row (0 gives the start state), the super action in this row (Frmt) can be performed from the start.

In another particularly suitable implementation form of the invention action paths and action trees with branchings are composed to super actions with parameters where the action path and the position of the parameters in the path or in the tree are stored.

The action path (see FIG. 15) shows the sequence of the actions—in the upper sample the teacher does the following actions:

| | |
|---|---|
| act A1 | it activates the cell A1 by left mouse click |
| dr B1 | it drags with pressed left mouse button to the cell B1 |
| act Bold | it activates the button Bold and thus formats the |
| | contents of A1:B1 to bold |
| act Fontcolor | it activates the button Fontcolor - the selection |
| | window Fontcolor opens |
| . . . | |

FIG. 3 shows an action tree with And Or-branchings:

In an And branching all branches must be performed whereas in an Or branching only one of the branches.

Now the student can follow any of the action sequences through the tree—e.g.:

| | |
|---|---|
| act A1 | at the first And branching he chooses And1 |
| hold Shift | |
| act B1 | |
| act Bold | at the second And branching he chooses And1-1 |
| act Red | then And1-2 |
| act 15 | then And1-3 |
| act E3 | now he takes And2 |
| instr Quartrer Sales | |
| act B3 | now he takes And3 |
| drag E3 | Or1 |
| act Bold | |

herewith he has performed all And branches and from each of the Or branches respectively one!
Substitution of an and Branching by the Information of that Actions that have to Be Performed Previously

The fact that these functions can be performed in any order arises from the fact that they all have the information ifdn=1—this means that they all can be performed as soon as rw=1 (Mark CISt, CIEn) is completed. By the information of the ifdn column a specific And branching is no longer necessary.

In an other particularly preferential implementation form the super actions of the lesson table access to a super action table (in particular according to table B) in which again the actions used for the single super actions and super actions with their generic parameters are shown (in particular according to the tables A and/or B).

In an other preferential implementation form of the invention for every action or super action exists a cell ‘ifdn’ which tells, which actions in which row has to be completed so that the action or super action of this row can be performed.

In another particularly suitable implementation form of the invention there exists a ‘sister table’ (in accordance to table C) which shows all different actions that lead to the same function as sisters of this function.

### Generation of Functions by Sister Tables

Functions represent a group of actions which solve the same task—as for example in Excel the task to format a marked cell or a cell compound to bold (e.g. by activation of Bold1—the Bold-button, by the action path Format/Cells/Font/Bold2 or by the key combination Ctrl+Shift+B).

To distinguish the different objects used for this they are numbered
Bold1 is the button for the direct activation
Bold2 is the button which appears only subsequent to activation of the objects ‘Format’ and ‘Cells’.
Bold is the name of the common function

| action | | sist1 | | sist2 | | sist3 | |
|---|---|---|---|---|---|---|---|
| act | Bold | act | Bold 1 | act | Bold 2 | inky | Ctrl + Shift + B |
| act | Ital | act | Ital 1 | act | Ital 2 | inky | Ctrl + Shift + I |
| act | Red | act | Red 1 | act | Red 2 | | |

si = sisters

If now the actions of the teacher and those of the student are compared, the sisters are analysed too—e.g. if the teacher activates the button Bold1 and the student the key combination Ctrl.+B the program Analyser ascertains conformity (see FIG. 12—cut out of the menu tree).

A summary of the compressed lesson table (table A), the super action table—here with the specific parameters —(table B) and the sister table (table C) is the action table ac=actions which can be generated automatically from these tables:

TABLE D
Action table

| Actv | un | rw | stat | ifdn | act1 | act2 | act3 |
|---|---|---|---|---|---|---|---|
| Frmt | 1 | 1 | 1 | 0 | A1 | | |
| | | 2 | | 1 | bld-1 | bld-2 | “Ctrl + B” |
| | | 3 | | 1 | 14-1 | 14-2 | |
| | | 4 | | 1 | red-1 | red-2 | |
| Instr | 2 | 1 | 1 | 0 | E3 | | |
| | | 2 | | 1 | “1. Quarter” | | |
| Instr | 3 | 1 | 1 | 0 | E4 | | |
| | | 2 | | 1 | “=SUM (B4:D4)” | | |

ac = actions

It shows the single actions which the student must perform at his repetition. With this table it can be seen which actions are ‘allowed’ at any status of the repetition: These are those actions for which for the respective super action in the compressed lesson table as well as for their single action in this table the status stat=1—as these are in the compressed lesson table the super actions Frmt1, Instr1 and Instr2 are these the actions that are shown italic—so: at the beginning only the cells A1 or E3 or E4 may be activated.

In a similar way the table can show which actions are allowed if the student had performed one of these action: If he has activated, e.g., A1, the respective action gets the status stat=2 (completed), and now all other actions of the corresponding super action Frmt1 with ifdn=1 get the status 1 and can get activated (above shown as italic)—now, e.g., the content of the cell A1 can be formatted to bold by input of the control key combination Ctrl+b.

In another advantageous implementation form of the invention functions are defined which correspond to a partial menu tree of the menu graph and which represent different solutions to the same task.

In an other advantageous implementation form the actions of the student are analysed if the last action can lead via an action path to an action that the teacher had done to solve one of the tasks of the lesson. For this analysis mainly the action tree (in particular according to FIG. 4) is used.

In another especially advantageous implementation form every cell of a table or an action tree can release an activity if it is used for the analysis of the actions of the student and if such a cell is marked with a preceding exclamation mark.

It is especially advantageous if such a cell refers—using a reference table—to that table in which the released activity is described. Such activities may be:
comments
logical operations
calculations
representation of pictures or videos
returns in the lesson, and/or
deepening lessons,
   where a combination of such activities is in particularly preferred.

In an other particularly suitable implementation form of the invention in a spoken comment the entity of the program to which the comment refers is marked by the cursor. If this entity is a button that changes its color with activation the cursor is lead to the activation area and shows thus the color change.

In another advantageous implementation form the presentation of the teaching unit by the teacher is done by the program part Recorder which records all actions of the teacher (mouse movements and—actions and key actions) together with the spoken comments—where an action consists always of an instruction an an object (an activatable entity).

### Tracking of the Actions of the Student by Analysis of Possible Action Paths

Instead of by tracking of before generated super actions—as for example the super action ‘Mark’ in FIG. 10 and table B—the actions of the student can be also analysed by investigation if one of his actions could form an action path which leads to one of the possible aim objects.

An example for is the cut out of the menu tree in FIG. 12: The teacher has formatted the cell compound A1:B1 to bold—in the lesson table (table A) this is documented by the parameter par3=Bold.

The student activates the button ‘Format’. Is this an allowed action which can solve one of the tasks of the lesson?

FIG. 12 shows that for this action an action path can be followed: act Format/act Cells/act Font (if not activate)/act Bold2 which performs this formatting: Hence: This is an allowed action! For the examination of the possibility of the action path the action tree can be checked in its tabular form (FIG. 4) as it was described before. It is important to say that this action tree must be generated only once for the teaching program!

Release from Comments and Other Activities by Single Cells

Every cell of a table or a tree can release an activity if it is used. A hint that the cell is prepared for this proceeding is given by the fact that at the left side of the content of the cell an exclamation mark is positioned—so the cell par4/rw1 in the lesson table in table A has the entry ‘! 14’.

This causes the following: If the meaning of the content of the cell is injured, e.g., by the fact that the student formats a wrong font size it refers in a reference table to a comment in a comment table:

‘This is not the right font-size!’
‘Compare your font size with that of the aim data in the lower part of the screen!’

| | |
|---|---|
| , Would you like to try again? | F1′ |
| , Would you want me to demonstrate the right solution? | F2′ |
| . . . | |

In the same way even more complex activities—e.g., with calculations and logical operators—can be released too. For this, e.g., instruction paths can be used:

TABLE E
Instruction path 11

| nr | nr | instr |
|---|---|---|
| 11 | 1 | mv + actcrs, E3, 500, 1 |
| | 2 | instr, “1. Quarter” |
| | 3 | mv + actcrs, bld-1, 300, 1 |

ip = instruction paths

If e.g., the instruction path 11 would have been called, the cursor would be moved in 500 ms to the cell E3 and would be activated there (the last parameter ‘1’). Then the string ‘1. Quarter’ would be input into this cell and then—by moving the cursor in 300 ms to the object Bold (bold1) and by activation of this object—the content of the cell would be formatted to bold.

### Cursor Application for Additional Explanations to Spoken Comments

At the reproduction of spoken comments in the presentation phase the cursor can be used as aid—the teacher uses it while giving a comment to show or declare an object by moving it into the activation zone of an object that changes hereby its color.

The movement of the cursor can be skipped too: The cursor may jump into the activation zone and leads thus to a color change without a visible movement.

For objects that should be highlighted at a comment and which do not change the color the cursor may jump into the object doing here a waving movement.

In another preferential implementation form the abovementioned features are combined with at least one of the in the following features.

Besides, the invention also concerns a computer product with a computer program that consists of software means for the performance of the invention-appropriate procedure if the computer program is performed in an automation system.

Besides, the invention concerns a data processing arrangement for the generation of didactic programs, containing a program which instructs the invention-appropriate procedure steps.

The characteristics of the invention being disclosed in the preceding description, the subsequent drawings and claims can be of importance both singularly and in arbitrary combination for the implementation of the invention in its different embodiments.

The foregoing description of preferred embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to hereby enable others skilled in the art to best utilize the invention in various embodiments and with various modifications as are suited to the particular use contemplated invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### LEGEND TO THE PICTURES

FIG. 1: Representation of an action in the unit graph

FIG. 2: Representation of an action path in the unit graph

FIG. 3: Action tree with branchings

FIG. 4: Action tree in tabular representation

FIG. 5: Tabular form of the action tree in FIG. 3

FIG. 6: Formula representation in the input line

FIG. 7a: Object Bold not activated

FIG. 7b: Object ‘Bold’ activated with 2 verification pixels

FIG. 8a: Line not being horizontal

FIG. 8b: Horizontal line with marker ‘Horizontal/Vertical’

FIG. 9: Part of an action tree for the super object Bold2

FIG. 10: Part of an action tree for the super action Mark

FIG. 11: Action path with super action and super object

FIG. 12: Cut out from the menu tree

FIG. 13. Representation of tasks of the lesson in tabular form

FIG. 14: Lesson graph

FIG. 15: Action path of the lesson

FIG. 16: Automatic enlargement of the action path to the action tree

FIG. 17: Teaching unit with And-branchings

### PATENT CLAIMS

1. Device for generating of didactic programs

2. Device subsequent to claim 1 where the didactic programs are composed of several single teaching units which are performed individually by the student.

3. Device subsequent to one of the preceding claims, in particular subsequent to claim 2, where the basic construction of a teaching unit consists in the fact that initially in a presentation phase a teaching material is performed that subsequently can be repeated by the student in a repetition phase.

4. Device subsequent to one of the preceding claims, in particular subsequent to claim 3, characterized in that for different learning qualifications different teaching units with different teaching speed can be generated.

5. Device subsequent to one of the preceding claims, in particular subsequent to claim 3 whereby the presentation simulates an instruction of a teacher to a great extent by the fact that the original surface of the teaching program is used.

6. Device subsequent to one of the preceding claims, in particular subsequent to claim 3, characterized in that the student can follow a way at the repetition which is different to that which the teacher had demonstrated, as long as his actions solve the tasks set in the presentation.

7. Device subsequent to one of the preceding claims, in particular subsequent to claim 3, characterized in that every action of the student is controlled at the repetition by an analysis program.

8. Device subsequent to one of the preceding claims, in particular subsequent to claim 7, characterized in that in this analysis an action tree which contains all possible actions of the student is compared with the actions of the student.

9. Device subsequent to one of the preceding claims, in particular subsequent to claim 7, characterized in that in this analysis tables with their parameters which describe all possible actions of the student are compared with tables which are generated by the student.

10. Device subsequent to one of the preceding claims, in particular subsequent to claim 7, characterized in that in this analysis a solution result—e.g., a text or graphic representation is compared with the result that is generated by the student.

11. Device subsequent to one of the preceding claims, in particular subsequent to claim 3, characterized in that the presentation of the teaching unit by the teacher—the lesson—is performed by the program part Recorder that records all actions of the teacher (mouse movements and—keystrokes and keyboard inputs) together with his spoken comments—whereby an action is always composed of an action instruction and an object.

12. Device subsequent to one of the preceding claims, in particular subsequent to claims 3, 8, and 11, characterized in that a ‘lesson graph’ is generated which represents every comment, every segment and every action of the teacher in written form—where a segment is an autonomous part of the teaching unit with own stored start screen.

13. Device subsequent to one of the preceding claims, in particular subsequent to claims 3 and 9, characterized in that this lesson graph is represented by the table of a spreadsheet program.

14. Device subsequent to one of the preceding claims, in particular subsequent to claims 3, 9 and 12, characterized in that this graph can be edited with the standard functions of the spreadsheet program.

15. Device subsequent to one of the preceding claims, in particular subsequent to claims 3, 9 and 12, characterized in that for an internal representation this graph can be automatically converted into a tabular form whereby to every action its mother's action is stored.

16. Device subsequent to one of the preceding claims, in particular subsequent to claims 3 and 12, characterized in that from the lesson graph—partly automatically—the lesson graph is generated which—in the case that the action tree analysis is performed—contains an action tree with all possible actions of the student and their branchings.

17. Device subsequent to one of the preceding claims, in particular subsequent to claims 3 and 12, characterized in that—if the table analysis is used—from the lesson graph—partly automatically—the set of tables is generated which contains every information that is necessary for the analysis of the student.

18. Device subsequent to one of the preceding claims, in particular subsequent to claims 3 and 12, characterized in that this graph with all actions, objects and their branchings—in the case that the action tree analysis is used—is represented by a table of a spreadsheet program.

19. Device subsequent to one of the preceding claims, in particular subsequent to claims 3 and 18, characterized in that action paths and action trees with branchings can be united to super actions with their parameters whereby the action path and the positions of the parameters are stored in the path or tree.

20. Device subsequent to one of the preceding claims, in particular subsequent to claims 3 and 19, characterized in that these super actions can be summarised again in the same manner to bigger super actions.

21. Device subsequent to one of the preceding claims, in particular subsequent to claims 3 and 16, characterized in that beside the lesson graph with the action tree a menu graph with the menu object tree is generated which contains all menu objects of the teaching program and all actions and action paths that solve the tasks without using objects—e.g., by input of key combinations.

22. Device subsequent to one of the preceding claims, in particular subsequent to claims 3 and 18, characterized in that with the help of this menu tree functions can be defined which are performed by action paths in this tree.

23. Device subsequent to one of the preceding claims, in particular subsequent to claims 3 and 19, characterized in that functions can be defined too which represent a partial menu tree in the menu graph and which represent different solutions of the same task.

24. Device subsequent to one of the preceding claims, in particular subsequent to claims 3 and 16, characterized in that for the enlargement of the action path shown in the lesson graphs fragments of the path are analysed whether they occur in the same kind in an entire branch of a super action, a super object or the menu tree—in this case they are substituted with the super action which super object or the corresponding function, so that they now—instead of representing a single solution of the lesson graph—represent now all other solutions.

25. Device subsequent to one of the preceding claims, in particular subsequent to claims 3, 7 and 8, characterized in that the analysis program gives a fault comment to faults of the student which—according to the default of the student—can be spoken or be written.

26. Device subsequent to one of the preceding claims, in particular subsequent to claims 3 and 25, characterized in that this comment is stored to the object or to the action or to the function which was ‘injured’ by this fault.

27. Device subsequent to one of the preceding claims, in particular subsequent to claim from 3 and 25 to 26, characterized in that the comment can be composed of generic and of parts that are specific for the object, the action or the function.

28. Device subsequent to one of the preceding claims, in particular subsequent to claim 3, characterized in that for special segments of the teaching unit intensifications are offered which get deeper into the shown learning content.

29. Device subsequent to one of the preceding claims, in particular subsequent to claim 3, characterized in that graphical structures which the student has generated, can be substituted by structures of the teacher, so that all of their positions on the screen are known for a treatment as objects.

30. Device subsequent to one of the preceding claims, in particular subsequent to claims 3 and 7, characterized in that the detection of the objects activated by the student can occur by the help of verification pixels that are stored to the objects—whose position and color are compared to those of the objects in the action tree or menu tree. These verification pixels can be determined by hand or be generated automatically by the program.

31. Device subsequent to one of the preceding claims, in particular subsequent to claims 3 and 7, characterized in that feature symbols which are automatically shown by the program (e.g., a line being horizontal or vertical) are detected by the program and are used to check whether the student has fulfilled the demand of this feature.

32. Device subsequent to one of the preceding claims, in particular subsequent to claims 3 and 7, characterized in that here are further object types with further mechanisms of detection—e.g. position objects which are detected by their position on the screen.

33. Device subsequent to one of the preceding claims, in particular subsequent to claim 3, characterized in that the student determines prior to the beginning of the teaching his learning aim whereby this aim profile is stored as a sum of all knowledge contents which allow the achievement of this aim

34. Device subsequent to one of the preceding claims, in particular subsequent to claim 3, characterized in that according to the definition of the learning aim a program part determines the actual knowledge profile of the student and generates hereby the gap profile as a difference of the learning aim profile and the actual knowledge profile.

35. Device subsequent to one of the preceding claims, in particular subsequent to claim 3, characterized in that for every teaching unit a unit profile is stored which contains the teaching contents of the teaching unit.

36. Device subsequent to one of the preceding claims, in particular subsequent to claims 3, 34 and 35, characterized in that subsequent to the end of every teaching unit the knowledge profile of the student is updated.

37. Device subsequent to one of the preceding claims, in particular subsequent to claim from 3 and 34 to 36, characterized in that dependent to the actual knowledge profile and the aim profile of the student, that teaching unit is chosen as next which fits bets to his gap profile and his learning speed profile.

38. Device subsequent to one of the preceding claims, in particular subsequent to claim 3, characterized in that the student can activate a help button if difficulties arise that offers him a repetition of the last action or the last segment done by the teacher, an intensification of the shown material (if this is prepared) or a change of the actual teaching speed.

39. Device subsequent to one of the preceding claims, in particular subsequent to claim 3, characterized in that the student can interrupt—if he wants—the presentation of the teacher and can begin an immediate repetition of the material taught till then.

40. Device subsequent to one of the preceding claims, in particular subsequent to claims 3 and 39, characterized in that the student and the teacher have an own screen and that the student repeats immediately every single action of the teacher—whereby both screens can be arranged side by side or may hide each other partially and can get activated either for the teacher or for the student.

41. Device subsequent to one of the preceding claims, in particular subsequent to claim 3, characterized in that subsequent to the end of the repetition phase the program offers to the student a unit with a similar task and with the same learning contents but without presentation by the teacher.

42. Device subsequent to one of the preceding claims, in particular subsequent to claim 3, characterized in that if the screen surface is unknown to the program a program part ‘Crawler’ determines automatically the parameters of the program surface, the menu objects and their windows.

43. Device subsequent to one of the preceding claims, in particular subsequent to claim 42, characterized in that this program disposes of a simulated cursor which can be moved by the program system arbitrarily on the surface of the student.

44. Device subsequent to one of the preceding claims, in particular subsequent to claims 42 and 43, characterized in that this program can activate mouse key strokes and key inputs while the program of the student is running and can evaluate their reactions by evaluation of the screen surface.

45. Device subsequent to one of the preceding claims, in particular subsequent to claim from 42 to 44, characterized in that the program can show and analyse the Font of the didactic program of the student by keyboard inputs and based on this can perform an optical character recognition of the characters shown on the surface of the student.

46. Device subsequent to one of the preceding claims, in particular subsequent to claim from 42 to 45, characterized in that the recognised strings can be standardised subsequent to stored default strings so that ambiguities for these strings which are allowed by the program can be removed.

47. Device subsequent to one of the preceding claims, in particular subsequent to claim 3, characterized in that the student can choose a learning mode which sends all his faults on the Internet back to the developer of the unit.

48. Device subsequent to one of the preceding claims, in particular subsequent to claim 3, characterized in that the testing of the teaching units is performed by persons who have a similar learning speed and a similar knowledge profile like the user to be expected.

49. Device subsequent to one of the preceding claims, in particular subsequent to claims 3 and 48, characterized in that the test process of these testers generates a test protocol which records all his actions and allows to protocol difficulties that occur during the test and that this test protocol is passed on to the developers of the unit.

50. Device subsequent to one of the preceding claims, in particular subsequent to claims 3 and 8, characterized in that can be stored for the single actions which other action or actions must be finished previous to this action or actions and that if this condition is hurt an adequate fault comment is given.

51. Device subsequent to one of the preceding claims, in particular subsequent to claims 3 and 9, characterized in that to the single functions of the tables it can be stored which previous action or actions must be finished, before this new function may be begun and that if this condition is hurt an adequate fault comment is given.

52. Device subsequent to one of the preceding claims, characterized in that in this analysis a compressed lesson table is used (mainly according to table A) with those actions or super actions and their specific parameters that are used in this lesson.

53. Device subsequent to one of the preceding claims, characterized in that action paths and action trees with branchings can be concentrated to super actions with parameters whereby the action path and the position of the parameters are stored in the path or tree.

54. Device subsequent to one of the preceding claims, characterized in that the super actions of this lesson table access to a super action table (mainly according to table B) in which the actions used for the single super actions and super actions with their generic parameters are shown.

55. Device subsequent to one of the preceding claims, characterized in that in the lesson as well as the super action table actions or super actions which can be performed alternatively, are marked by a numbered Or-instruction.

56. Device subsequent to one of the preceding claims, characterized in that for every action or super action a cell ‘ifdn’ exists which tells which action in which row must have been already performed before the action (or super action) of this row can be performed.

57. Device subsequent to one of the preceding claims, characterized in that to functions (group of actions which solve the same task) a sister table (mainly according to table C) is generated which shows all different actions of the function as sisters.

58. Device subsequent to one of the preceding claims, characterized in that functions can be defined too which correspond to a partial menu tree in the menu graph and which represent different solutions of the same task.

59. Device subsequent to one of the preceding claims, characterized in that it is examined for the analysis of the action of the student whether an actual action of the student can lead by following an action path to an action which the teacher has performed for the solution of one of the tasks of the lesson. For this the action tree in tabular representation (mainly according to FIG. 4) can be used.

60. Device subsequent to one of the preceding claims, characterized in that every cell of a table or an action tree that is used for the analysis of the actions of the student can release an activity—if such a cell is marked with a preceeding exclamation mark

61. Device subsequent to claim 60, characterized in that such a cell refers via a reference table to other tables in which the released activity is described; such activities can be, e.g.:
Comments
Logical operations
Calculations
Representation of pictures or videos
Loop back in the lesson
Help lessons and other more

62. Device subsequent to one of the preceding claims, characterized in that with spoken comments, the entity of the program to which the comment refers is marked by the cursor—if this entity changes its color at activation the cursor jumps into the button and triggers hereby the color change—in all other cases the cursor does under the area of the entity a bidirectional movement for the marking of the entity

63. Device subsequent to one of the preceding claims, characterized in that the presentation of the teaching unit by the teacher—the lesson—is done by the program part Recorder which records all actions of the teacher (mouse movements and—keystrokes and keyboard inputs) together with his spoken comments whereby an action contains always an action instruction and an object—an activateable entity.

64. Device subsequent to one of the preceding claims, characterized in that an action table (according to table D) can be generated by combination of parts of the compressed lesson table, the super action table and the sister table (partially automatically) which shows which actions are allowed actually for the student.

65. Device subsequent to one of the preceding claims, mainly according to one of the claims from 59 to 61, characterized in that for this aim instruction path tables can be used which cause a sequence of actions to explain something to the student.

66. Procedures to electronic generation of didactic programs which are composed of single teaching units which are performed individually by a student where every teaching unit encloses
(a) a demonstration phase in which teaching material is demonstrated to the student which shall be repeated by him later
(b) a repetition phase in which the repeated material of the student is analysed characterized in that every action of the student is controlled at the repetition phase by an analysis program.

67. Procedures subsequent to claim 66, characterized in that in this analysis a compressed lesson table with actions or super action and their specific parameters is used (mainly according to table A).

68. Procedures subsequent to one of the claims 66-67, characterized in that action paths and action trees with branchings can be compressed to super actions with parameters whereby the action path and the position of the parameters are stored in the path or tree.

69. Procedures subsequent to one of the claims 67-68, characterized in that the super actions of this lesson table access to a super action table (mainly according to table B) in which the actions used for the single super actions and super actions with their generic parameters are exposed.

70. Procedures subsequent to one of the claims 67-69, characterized in that in the lesson as well as the super action table actions or super actions which can be performed alternatively, are marked by a numbered Or-instruction.

71. Procedures subsequent to one of the claims 67-70, characterized in that for every action or super action a cell ‘ifdn’ exists which tells which action in which row must have been already completed before this action can be performed.

72. Device subsequent to one of the claims 66-71, characterized in that to functions (group of actions which solve the same task) a sister table (mainly according to table C) is generated which shows all different actions of the function as sisters.

73. Procedures subsequent to one of the claims 66-72, characterized in that functions can be defined which correspond to a partial menu tree in the menu graph which represent different solutions of the same task.

74. Procedures subsequent to one of the claims 66-73, characterized in that it is examined for the analysis of the action of the student whether a presently performed action of the student can lead by following an action path to an action which the teacher has performed for the solution of one of the tasks of the lesson. For this the action tree the table representation (mainly according to FIG. 4) is used.

75. Procedures subsequent to one of the claims 66-74, characterized in that every cell of a table or an action that is used for the analysis of the actions of the student tree can release an activity and if such a cell is marked, e.g., with a preceding exclamation mark.

76. Procedures subsequent to claim 75, characterized in that such a cell refers using a reference table to tables in which the released activity is described; such activities can be, e.g.:
Comments
Logical linkings
Calculations
Representation of pictures or videos
Back jumps in the lesson
Help lessons and other more

77. Procedure subsequent to one of the claims 66-76, characterized in that with spoken comments, the entity of the program to which the comment refers is marked by the cursor—if it concerns a button with color change at activation the cursor jumps in the button and releases hereby the color change—in all other cases it marks the entity by doing waving movements under the surface of the entity.

78. Procedures subsequent to one of the claims 66-77, characterized in that the presentation of the teaching unit done by the teacher—the lesson—is done by the program Recorder, which records through which program part recorder occurs, all actions of the teacher (mouse movements and mouse keystrokes and keyboard inputs) together with his spoken comments whereby an action always contains an action instruction and an object—an activateable unit.

79. Procedures subsequent to one of the claims 58-78, characterized in that an action table (according to table D) can be generated by composing of the compressed lesson table, the super action table and the sister table (automatically) which shows which actions are permitted in each case for the student.

80. Procedures subsequent to one of the claims 58-78, mainly according to one of the claims from 74 to 76, characterized in that herefore instruction paths can be used that cause a sequence of actions to demonstrate something to the student.

81. Procedures subsequent to one of the claims 66-80, characterized in that the step or the steps is performed according to one or several of the claims 1-51.

82. Computer product with a computer program, that has software means for the realisation of a procedure according to one of the claims 66-81 if the computer program is performed in an automation system.

83. Data processing arrangement for generating of didactic programs, containing a program which instructs the steps according to one of the claims 66-81.

### SUMMARY

The invention concerns a program system which simulates a teacher who teaches a complex program system to a student in single lessons. Areas of application are all educational areas, from the housewife who would like to learn Word up to the certified engineer who would like to learn a new complicated design program.

Objective of the present patent application is hence to develop a program system which simulates a teacher as much as possible, is simple to be served and to be generated and, moreover, as a reasonable teaching alternative that is available for a wide user forum.

The invention-appropriate device serves for generating of didactic programs whereby the didactic programs are composed of several single teaching units which are performed individually by the student. The basic design of a teaching unit consists in the fact that first in a presentation phase a teaching material is demonstrated that thereafter can be repeated in a repetition phase by the student.

1-83. (canceled)

84. A device for generating didactic programs.

85. The device of claim 84, said didactic programs comprising several single teaching units which are performed individually by a student, and wherein initially in a presentation phase a teaching material is performed that subsequently can be repeated by the student in a repetition phase.

86. The device of claim 84, wherein the presentation simulates an instruction of a teacher by presenting an original surface of the teaching program.

87. The device of claim 84 wherein a student follows a way at the repetition which is different to that which the teacher had demonstrated, as long as his actions solve the tasks set in the presentation and wherein every action of the student is controlled at the repetition by an analysis program and wherein an action tree which contains all possible actions of the student is compared with the actions of the student.

88. The device of claim 84, wherein a lesson graph is generated which represents every comment, every segment and every action of a teacher in written form, and wherein where a segment is an autonomous part of a teaching unit with its own stored start screen, wherein the lesson graph is represented by the table of a spreadsheet program and wherein the lesson graph is able to be edited with the standard functions of the spreadsheet program.

89. The device of claim 84 said programs comprising analysis tables with parameters that describe all possible actions of the student compared with tables which are generated by the student, wherein in this analysis a solution result is compared with the result that is generated by the student.

90. The device of claim 89 wherein for an internal representation the analysis tables are presented as a lesson graph that can be automatically converted into a tabular form whereby to every action its generating action is stored.

91. The device of claim 90 wherein from the lesson graph the action tree is generated which contains all possible actions of the student and their branchings, wherein that action paths and action trees with branchings are be uniteable to super actions with their parameters, whereby the action path and the positions of the parameters are storeable in the path or tree and more preferably these super actions are summariseable in the same manner to bigger super actions.

92. The device of claim 91, further comprising a menu graph with the menu object tree is generated which contains all menu objects of the teaching program and all actions and action paths that solve the tasks without using objects.

93. The device of claim 84, said programs comprising defined functions which represent a partial menu tree in the menu graph and which represent different solutions of the same task.

94. The device of claim 87 wherein the analysis program gives a fault comment to faults of the student which, according to the default of the student, is spoken or be written.

95. The device of claim 94 wherein said comment is concatenated with generic parts, triggered by the type of fault, and specific parts, given by the specific parameters of the tables which where injured by the action of the student.

96. The device of claim 91 wherein graphical structures which the student has generated, are substituteable by structures of the teacher, so that all of their positions on the screen are known for a treatment as objects.

97. The device of claim 84, comprising feature symbols automatically shown by the program and detected by the program, wherein said feature symbols are used to check whether a student has fulfilled a demand of this feature.

98. The device of claim 85 wherein the student determines prior to the beginning of the teaching his learning aim whereby this aim profile is stored as a sum of all knowledge contents which allow the achievement of this aim and that according to the definition of the learning aim a program part determines the actual knowledge profile of the student and generates hereby the gap profile as a difference of the learning aim profile and the actual knowledge profile.

99. The device of claim 85, wherein prior to beginning of the teaching the general learning speed of the students is determined by tests and that is stored to the other parameters of the student's profile.

100. The device of claim 98, wherein the profile of the student is updated after each lesson, and wherein the new contents diminish the knowledge gap, the number or the lack of faults may change the learning speed.

101. The device of claim 98, wherein parallel to the student's profile every teaching unit has its own profile characterizing its knowledge contents and its teaching speed and that prior to every teaching session it is checked which unit profile fits best to the profile of the students.

102. Procedures for electronic generation of didactic programs which are composed of single teaching units which are performed individually by a student where every teaching unit comprises:
(a) a demonstration phase in which teaching material is demonstrated to the student which shall be repeated by him later; and
(b) a repetition phase in which the repeated material of the student is analysed, every action of the student is controlled at the repetition phase by an analysis program.

103. The procedure of claim 102 wherein the student in every step of the repetition phase can activate a help button and ask for a member of the group consisting of a repetition of the last action of the demonstration of the teacher;
a repetition of the last segment of the demonstration of the teacher
a intensification unit for a special complex content of the demonstration;
a diminishing or increase of the teaching speed of the teacher (changing the learning speed parameter in his profile); and
a demonstration by the teacher which actions would be possible at this step.

104. The procedure of claim 102, wherein the student can determine if he wants a single step repetition where he can redo every action of the teacher immediately using a split screen where one screen is used by the teacher and the other by the student.

105. The procedure of claim 102 wherein the student after the end of the repetition phase can determine a new task for the same knowledge contents but without preceding demonstration.

106. The procedure of claim 102, wherein action paths and action trees with branchings are compressed to super actions with parameters, wherein the action path and the position of the parameters are stored in the path or tree and the super actions of this lesson table access to a super action table in which the actions used for the single super actions and super actions with their generic parameters are exposed and the lesson as well as the super action table actions or super actions which can be performed alternatively, are marked by a numbered Or-instruction, and for every action or super action a cell exists which tells which action in which row must have been already completed before this action can be performed.

107. The procedure of claim 102, wherein for functions a sister table is generated which shows all different actions of the function as sisters.

108. The procedure of claim 102, wherein every cell of a table or an action that is used for the analysis of the actions of the student tree can release an activity and if such a cell is marked, wherein such a cell refers using a reference table to tables in which the released activity is described; and wherein said activities are selected from the group consisting of comments, logical linkings, calculations, representation of pictures or videos, back jumps in the lesson, and help lessons.

109. The procedure of claim 102, wherein an action table is generated by composing of the compressed lesson table, the super action table and the sister table, which shows which actions are permitted in each case for the student and which instruction paths can be used that cause a sequence of actions to demonstrate something to the student.

110. A data processing arrangement for generating of didactic programs, comprising a program which instructs the steps according to claim 102.
